(19) United States
(12) Patent Application Publication
(10) Pub. No.: US 2020/0378489 A1
(43) Pub. Date: Dec. 3, 2020

(54) VIBRATION DAMPING DEVICE

(71) Applicant: AISIN AW CO., LTD., Anjo-shi, Aichi-ken (JP)

(72) Inventors: Yoichi OI, Ama, Aichi (JP); Takao SAKAMOTO, Anjo, Aichi (JP); Hiroki NAGAI, Anjo, Aichi (JP)

(73) Assignee: AISIN AW CO., LTD., Anjo-shi, Aichi-ken (JP)

(21) Appl. No.: 16/496,652

(22) PCT Filed: Apr. 27, 2018
(86) PCT No.: PCT/JP2018/017297

§ 371 Date: Sep. 23, 2019

(30) Foreign Application Priority Data
Apr. 28, 2017 (JP) 2017-089285

(51) Int. Cl. F16H 57/00; F16F 15/14

(52) U.S. Cl. CPC F16H 57/0006; F16H 57/0018; F16F 15/145

(57) ABSTRACT

A vibration damping device including a support member that rotates with a rotary element that receives engine torque; a restoring force generating member coupled to the support member and swingable with rotation of the support member; an inertial mass body that, with rotation of the support member, swings about the center of rotation in conjunction with the restoring force generating member; a guided portion formed in either the restoring force generating member and the inertial mass body; and a guide portion formed in the other of the restoring force generating member and the inertial mass body and configured to guide the guided portion. As the guided portion is guided by the guide portion, the restoring force generating member swings with respect to the center of rotation in the radial direction of the support member and the inertial mass body swings about the center of rotation when the support member rotates.

### CROSS REFERENCE TO RELATED APPLICATIONS

This application is a National Stage of International Application No. PCT/JP2018/017297 filed Apr. 27, 2018, claiming priority based on Japanese Patent Application No. 2017-089285 filed Apr. 28, 2017.

### TECHNICAL FIELD

The disclosure relates to vibration damping devices including a restoring force generating member that can swing as a support member rotates and an inertial mass body that is coupled to the support member via the restoring force generating member and swings in conjunction with the restoring force generating member as the support member rotates.

### BACKGROUND ART

Conventionally, a torque fluctuation restraining device including: a mass body disposed next to a rotary body in the axial direction and disposed so as to be rotatable relative to the rotary body; centrifugal elements disposed in recessed portions formed in the rotary body so that the centrifugal elements are movable in the radial direction and so that the centrifugal elements receive a centrifugal force that is generated by rotation of the rotary body and the mass body; and cam mechanisms each having a cam provided in the centrifugal element or one of the rotary body and the mass body and a cam follower provided in one of the rotary body and the mass body or the centrifugal element is known as a torque fluctuation restraining device that restrains torque fluctuation of a rotary body to which torque from an engine is applied (see, e.g., Patent Document 1). When the rotary element and the mass body are displaced relative to each other in the rotation direction due to the centrifugal force applied to the centrifugal elements, the cam mechanisms of this torque fluctuation restraining device convert the centrifugal force to a circumferential force in such a direction that the relative displacement is reduced. As the centrifugal force applied to the centrifugal elements is thus used as a force for restraining torque fluctuation, torque fluctuation restraining characteristics can be varied according to the rotational speed of the rotary body.

### RELATED ART DOCUMENTS

### Patent Documents

Patent Document 1: Japanese Patent Application Publication No. 2017-53467 (JP 2017-53467 A)

### SUMMARY OF THE DISCLOSURE

The torque fluctuation restraining device described in Patent Document 1 can provide satisfactorily vibration damping capability if the order of this device is the same as the excitation order of the engine. Moreover, since the centrifugal elements are disposed in the recessed portions formed in the rotary body so that the centrifugal elements are movable in the radial direction, reduction in order due to operation of the centrifugal elements can be restrained. However, in the torque fluctuation restraining device described in Patent Document 1, the centrifugal force that is used as a force for restraining torque fluctuation is damped by a friction force that is generated between the centrifugal elements and the rotary body (the inner wall surfaces of the recessed portions). The torque fluctuation restraining device described in Patent Document 1 therefore may not provide a satisfactory vibration damping effect. In this torque fluctuation restraining device, radial movement of the centrifugal elements is guided by the rotary body. In this case, if there is large clearance between the recessed portion of the rotary element and the centrifugal element, the centrifugal element wobbles within the clearance, which may result in a larger friction force being generated between the centrifugal element and the rotary body. If the clearance between the recessed portion of the rotary element and the centrifugal element is too small, a large friction force is also generated between the centrifugal element and the rotary body. Moreover, if the centrifugal element bites into the inner wall surface of the recessed portion and can no longer swing with respect to the rotary element, the torque fluctuation restraining device can no longer provide any vibration damping effect.

It is an aspect of the present disclosure to further improve vibration damping capability of a vibration damping device including a restoring force generating member that swings in the radial direction of a support member as the support member rotates and an inertial mass body that swings in conjunction with the restoring force generating member.

A vibration damping device of the present disclosure is a vibration damping device including a support member that rotates, together with a rotary element to which torque from an engine is transmitted, about a center of rotation of the rotary element, a restoring force generating member that is coupled to the support member so as to transmit and receive the torque to and from the support member and that is swingable with rotation of the support member, and an inertial mass body that is coupled to the support member via the restoring force generating member and that, with rotation of the support member, swings about the center of rotation in conjunction with the restoring force generating member. The vibration damping device further includes: a guided portion formed in one of the restoring force generating member and the inertial mass body; and a guide portion formed in the other of the restoring force generating member and the inertial mass body and configured to guide the guided portion. As the guided portion is guided by the guide portion, the restoring force generating member swings with respect to the center of rotation in a radial direction of the support member and the inertial mass body swings about the center of rotation when the support member rotates.

In the vibration damping device of the present disclosure, when the support member rotates with the rotary element, the guided portion formed in one of the restoring force generating member and the inertial mass body is guided by the guide portion formed in the other of the restoring force generating member and the inertial mass body. The restoring force generating member thus swings in the radial direction of the support member, and the inertial mass body swings about the center of rotation in conjunction with the restoring force generating member. When the inertial mass body swings about the center of rotation, the inertial mass body applies torque in opposite phase to fluctuating torque that is transmitted from the engine to the rotary member to the support member via the restoring force generating member. Vibration of the rotary element can thus be satisfactorily damped. In the vibration damping device of the present disclosure, motion of the restoring force generating member coupled to the support member is defined (constrained) by the guided portion and the guide portion which are formed in the restoring force generating member and the inertial mass body. The restoring force generating member is thus not allowed to rotate on its own axis, so that reduction in order of the vibration damping device due to rotation of the restoring force generating member on its own axis can be restrained. Moreover, the restoring force generating member is allowed to smoothly swing with respect to the support member, so that damping of a centrifugal force (its component) acting on the restoring force generating member, which is used as a restoring force for swinging the inertial mass body, can be restrained. As a result, vibration damping capability of the vibration damping device including the restoring force generating member that swings in the radial direction of the support member with rotation of the support member can further be improved.

### BRIEF DESCRIPTION OF THE DRAWINGS

FIG. 1 is a schematic configuration diagram of a starting device including a vibration damping device of the present disclosure.

FIG. 2 is a sectional view of the starting device shown in FIG. 1.

FIG. 3 is an enlarged view of the vibration damping device of the present disclosure.

FIG. 4 is an enlarged sectional view of a main part of the vibration damping device of the present disclosure.

FIG. 5 is an enlarged sectional view of a main part of the vibration damping device of the present disclosure.

FIG. 6 is an enlarged view of the vibration damping device of the present disclosure.

FIG. 7 is an enlarged view of a modification of the vibration damping device of the present disclosure.

FIG. 8 is an enlarged view of another vibration damping device of the present disclosure.

FIG. 9 is an enlarged sectional view of a main part of the another vibration damping device of the present disclosure.

FIG. 10 is an enlarged sectional view of a main part of the another vibration damping device of the present disclosure.

FIG. 11 is a schematic configuration diagram of a modification of a damper device including the vibration damping device of the present disclosure.

FIG. 12 is a schematic configuration diagram of another modification of the damper device including the vibration damping device of the present disclosure.

### DETAILED DESCRIPTION

Modes for carrying out the various aspects of the present disclosure will be described below with reference to the accompanying drawings.

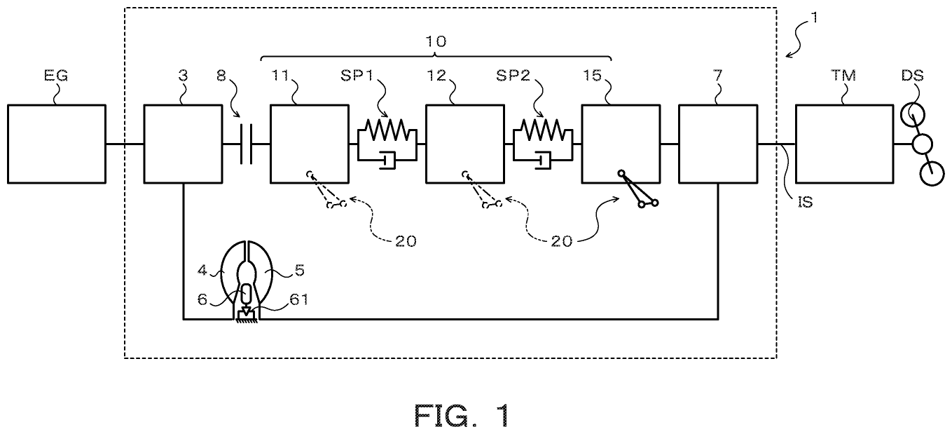

FIG. 1 is a schematic configuration diagram of a starting device 1 including a vibration damping device 20 of the present disclosure. The starting device 1 shown in the figure is mounted on, e.g., a vehicle including an engine (internal combustion engine) EG serving as a drive device and serves to transmit power from the engine EG to drive shafts DS of the vehicle. The starting device 1 includes, in addition to the vibration damping device 20, a front cover 3 coupled to a crankshaft of the engine EG and serving as an input member, a pump impeller (input-side hydraulic transmission element) 4 that is fixed to the front cover 3 and rotates together with the front cover 3, a turbine runner (output-side hydraulic transmission element) 5 capable of rotating coaxially with the pump impeller 4, a damper hub 7 fixed to an input shaft IS of a transmission (power transmission device) TM, which is an automatic transmission (AT), a continuously variable transmission (CVT), a dual clutch transmission (DCT), a hybrid transmission, or a reduction gear, and serving as an output member, a lockup clutch 8, a damper device 10, etc.

In the following description, the “axial direction” basically refers to the direction in which the central axis (axis) of the starting device 1 or the damper device 10 (vibration damping device 20) extends, unless otherwise specified. The “radial direction” basically refers to the radial direction of the starting device 1, the damper device 10, or rotary elements of the damper device 10 etc., namely the direction of a straight line extending from the central axis of the starting device 1 or the damper device 10 perpendicularly to this central axis (in the direction of the radius), unless otherwise specified. The “circumferential direction” basically refers to the circumferential direction of the starting device 1, the damper device 10, or the rotary elements of the damper device 10 etc., namely the direction along the rotation direction of the rotary elements, unless otherwise specified.

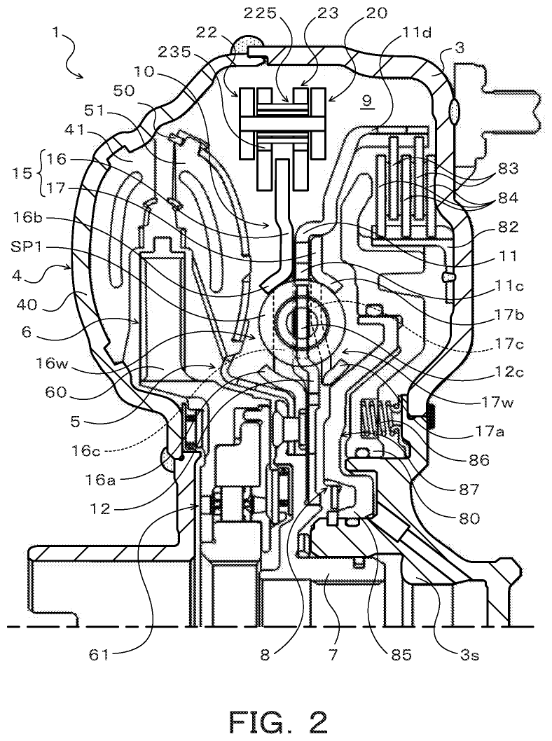

As shown in FIG. 2, the pump impeller 4 has a pump shell 40 firmly fixed to the front cover 3, and a plurality of pump blades 41 formed on the inner surface of the pump shell 40. As shown in FIG. 2, the turbine runner 5 has a turbine shell 50 and a plurality of turbine blades 51 formed on the inner surface of the turbine shell 50. An inner peripheral part of the turbine shell 50 is fixed to the damper hub 7 via a plurality of rivets.

The pump impeller 4 and the turbine runner 5 face each other, and a stator 6 that adjusts the flow of hydraulic oil (working fluid) from the turbine runner 5 to the pump impeller 4 is disposed coaxially between the pump impeller 4 and the turbine runner 5. The stator 6 has a plurality of stator blades 60, and the stator 6 is allowed to rotate in only one direction by a one-way clutch 61. The pump impeller 4, the turbine runner 5, and the stator 6 form a torus (annular flow path) in which hydraulic oil is circulated, and function as a torque converter (hydraulic transmission device) having a torque amplifying function. In the starting device 1, the stator 6 and the one-way clutch 61 may be omitted, and the pump impeller 4 and the turbine runner 5 may function as a fluid coupling.

The lockup clutch 8 is configured as a hydraulic multi-plate clutch. The lockup clutch 8 performs lockup coupling, namely couples the front cover 3 to the damper hub 7, i.e., the input shaft IS of the transmission TM, via the damper device 10, and releases the lockup coupling. The lockup clutch 8 includes: a lockup piston 80 that is supported by a centerpiece 3s fixed to the front cover 3 so that the lockup piston 80 is movable in the axial direction; a drum portion 11d that is integral with a drive member 11, namely an input element of the damper device 10, and serves as a clutch drum; an annular clutch hub 82 that is fixed to the inner surface of the front cover 3 so as to face the lockup piston 80; a plurality of first friction engagement plates (friction plates each having a friction material on its both surfaces) 83 that are fitted on splines formed on the inner periphery of the drum portion 11d; and a plurality of second friction engagement plates (separator plates) 84 that are fitted on splines formed on the outer peripheral surface of the clutch hub 82.

The lockup clutch 8 further includes: an annular flange member (oil chamber defining member) 85 that is attached to the centerpiece 3s of the front cover 3 so as to be located on the opposite side of the lockup piston 80 from the front cover 3, namely so as to be located closer to the damper device 10 than the lockup piston 80 is; and a plurality of return springs 86 that are disposed between the front cover 3 and the lockup piston 80. As shown in the figure, the lockup piston 80 and the flange member 85 define an engagement oil chamber 87, and hydraulic oil (engagement oil pressure) is supplied from a hydraulic control device, not shown, to the engagement oil chamber 87. By increasing the engagement oil pressure that is supplied to the engagement oil chamber 87, the lockup piston 80 is moved in the axial direction so as to press the first and second friction engagement plates 83, 84 toward the front cover 3, whereby the lockup clutch 8 can be engaged (fully engaged or slip-engaged). The lockup clutch 8 may be configured as a hydraulic single-plate clutch.

As shown in FIGS. 1 and 2, the damper device 10 includes, as the rotary elements, the drive member (input element) 11 including the drum portion 11d, an intermediate member (intermediate element) 12, and a driven member (output element) 15. The damper device 10 further includes, as torque transmission elements, a plurality of first springs (first elastic bodies) SP1 and a plurality of second springs (second elastic bodies) SP2 (e.g., four each in the present embodiment) which are alternately arranged at intervals in the circumferential direction on the same circumference. The first and second springs SP1, SP2 are arc coil springs each made of a metal material wound so that the spring SP1, SP2 has an axis extending in the shape of a circular arc when not under load, or straight coil springs each made of a metal material wound in a helical pattern so that the spring SP1, SP2 has an axis extending straight when not under load. As shown in the figures, the first and second springs SP1, SP2 may be what is called dual springs.

The drive member 11 of the damper device 10 is an annular member including the drum portion 11d on its outer peripheral side and has a plurality of (e.g., four at 90° intervals in the present embodiment) spring contact portions 11c extended radially inward from its inner peripheral portion at intervals in the circumferential direction. The intermediate member 12 is an annular plate-like member and has a plurality of (e.g., four at 90° intervals in the present embodiment) spring contact portions 12c extended radially inward from its outer peripheral portion at intervals in the circumferential direction. The intermediate member 12 is rotatably supported by the damper hub 7 and is disposed radially inside the drive member 11 and surrounded by the drive member 11.

As shown in FIG. 2, the driven member 15 includes an annular first driven plate 16 and an annular second driven plate 17 coupled to the first driven plate 16 via a plurality of rivets, not shown, so as to rotate therewith. The first driven plate 16 is configured as a plate-like annular member and is disposed closer to the turbine runner 5 than the second driven plate 17 is. The first driven plate 16 together with the turbine shell 50 of the turbine runner 5 is fixed to the damper hub 7 via a plurality of rivets. The second driven plate 17 is configured as a plate-like annular member having a smaller inside diameter than the first driven plate 16, and an outer peripheral portion of the second driven plate 17 is fastened to the first driven plate 16 via a plurality of rivets, not shown.

The first driven plate 16 has: a plurality of (e.g., four in the present embodiment) spring accommodating windows 16w formed at intervals (regular intervals) in the circumferential direction and each extending in the shape of a circular arc; a plurality of (e.g., four in the present embodiment) spring support portions 16a formed at intervals (regular intervals) in the circumferential direction and each extending along the inner peripheral edge of a corresponding one of the spring accommodating windows 16w; a plurality of (e.g., four in the present embodiment) spring support portions 16b formed at intervals (regular intervals) in the circumferential direction and each extending along the outer peripheral edge of a corresponding one of the spring accommodating windows 16w and facing a corresponding one of the spring support portions 16a in the radial direction of the first driven plate 16; and a plurality of (e.g., four in the present embodiment) spring contact portions 16c. The plurality of spring contact portions 16c of the first driven plate 16 are formed so that one spring contact portion 16c is located between every two of the spring accommodating windows 16w (spring support portions 16a, 16b) which are adjacent to each other in the circumferential direction.

The second driven plate 17 also has: a plurality of (e.g., four in the present embodiment) spring accommodating windows 17w formed at intervals (regular intervals) in the circumferential direction and each extending in the shape of a circular arc; a plurality of (e.g., four in the present embodiment) spring support portions 17a formed at intervals (regular intervals) in the circumferential direction and each extending along the inner peripheral edge of a corresponding one of the spring accommodating windows 17w; a plurality of (e.g., four in the present embodiment) spring support portions 17b formed at intervals (regular intervals) in the circumferential direction and each extending along the outer peripheral edge of a corresponding one of the spring accommodating windows 17w and facing a corresponding one of the spring support portions 17a in the radial direction of the second driven plate 17; and a plurality of (e.g., four in the present embodiment) spring contact portions 17c. The plurality of spring contact portions 17c of the second driven plate 17 are formed so that one spring contact portion 17c is located between every two of the spring accommodating windows 17w (spring support portions 17a, 17b) which are adjacent to each other in the circumferential direction. In the present embodiment, as shown in FIG. 2, the drive member 11 is rotatably supported by the outer peripheral surface of the second driven plate 17 that is supported by the damper hub 7 via the first driven plate 16. The drive member 11 is thus aligned with respect to the damper hub 7.

In the damper device 10 mounted in position, one first spring SP1 and one second spring SP2 are disposed between every adjacent two of the spring contact portions 11c of the drive member 11 so that the first and second springs SP1, SP2 are alternately arranged in the circumferential direction of the damper device 10. Each spring contact portion 12c of the intermediate member 12 is located between the first and second springs SP1, SP2 that are disposed as a pair (act in series) between adjacent two of the spring contact portions 11c, and contacts the ends of these first and second springs SP1, SP2. Accordingly, in the damper device 10 mounted in position, one end of each of the first springs SP1 contacts a corresponding one of the spring contact portions 11c of the drive member 11, and the other end of each of the first springs SP1 contacts a corresponding one of the spring contact portions 12c of the intermediate member 12. In the damper device 10 mounted in position, one end of each of the second springs SP2 contacts a corresponding one of the spring contact portions 12c of the intermediate member 12, and the other end of each of the second springs SP2 contacts a corresponding one of the spring contact portions 11c of the drive member 11.

As can be seen from FIG. 2, each of the plurality of spring support portions 16a of the first driven plate 16 supports (guides) the sides on the turbine runner 5 side of a corresponding pair of first and second springs SP1, SP2 from inside in the radial direction. Each of the plurality of spring support portions 16b supports (guides) the sides on the turbine runner 5 side of a corresponding pair of first and second springs SP1, SP2 from outside in the radial direction. Moreover, as can be seen from FIG. 2, each of the plurality of spring support portions 17a of the second driven plate 17 supports (guides) the sides on the lockup piston 80 side of a corresponding pair of first and second springs SP1, SP2 from inside in the radial direction. Each of the plurality of spring support portions 17b supports (guides) the sides on the lockup piston 80 side of a corresponding pair of first and second springs SP1, SP2 from outside in the radial direction.

Like the spring contact portions 11c of the drive member 11, in the damper device 10 mounted in position, each of the spring contact portions 16c and each of the spring contact portions 17c of the driven member 15 are located between the first and second springs SP1, SP2 that are not paired (do not act in series), and contact the ends of these first and second springs SP1, SP2. Accordingly, in the damper device 10 mounted in position, the one end of each of the first springs SP1 also contacts a corresponding one of the spring contact portions 16c and a corresponding one of the spring contact portions 17c of the driven member 15, and the other end of each of the second springs SP2 also contacts a corresponding one of the spring contact portions 16c and a corresponding one of the spring contact portions 17c of the driven member 15. The driven member 15 is thus coupled to the drive member 11 via the plurality of first springs SP1, the intermediate member 12, and the plurality of second springs SP2, and the first and second springs SP1, SP2 that are paired are coupled in series between the drive member 11 and the driven member 15 via the spring contact portions 12c of the intermediate member 12. In the present embodiment, the distance between the axis of the starting device 1 and the damper device 10 and the axis of each of the first springs SP1 is the same as that between the axis of the starting device 1 etc. and the axis of each of the second springs SP2.

The damper device 10 of the present embodiment further includes a first stopper that restricts relative rotation between the intermediate member 12 and the driven member 15 and deflection of the second springs SP2, and a second stopper that restricts relative rotation between the drive member 11 and the driven member 15. The first stopper is configured to restrict relative rotation between the intermediate member 12 and the driven member 15 when torque that is transmitted from the engine EG to the drive member 11 reaches predetermined torque (first threshold value) T1 smaller than torque T2 (second threshold value) corresponding to a maximum torsion angle of the damper device 10. The second stopper is configured to restrict relative rotation between the drive member 11 and the driven member 15 when torque that is transmitted to the drive member 11 reaches the torque T2 corresponding to the maximum torsion angle. The damper device 10 thus has two-step (two-stage) damping characteristics. The first stopper may be configured to restrict relative rotation between the drive member 11 and the intermediate member 12 and deflection of the first springs SP1. The damper device 10 may include a stopper that restricts relative rotation between the drive member 11 and the intermediate member 12 and deflection of the first springs SP1, and a stopper that restricts relative rotation between the intermediate member 12 and the driven member 15 and deflection of the second springs SP2.

The vibration damping device 20 is coupled to the driven member 15 of the damper device 10 and is disposed in a hydraulic transmission chamber 9 filled with hydraulic oil. As shown in FIGS. 2 to 5, the vibration damping device 20 includes the first driven plate 16 serving as a support member, a plurality of (e.g., three in the present embodiment) weight bodies 22 coupled to the first driven plate 16 so as to transmit and receive torque to and from the first driven plate 16 and each serving as a restoring force generating member, and a single annular inertial mass body 23 coupled to the weight bodies 22.

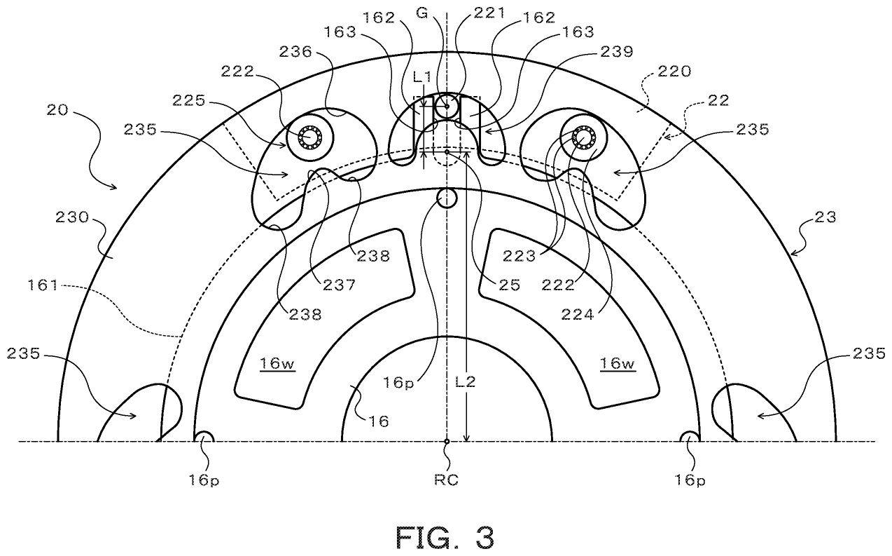

As shown in FIG. 3, the first driven plate 16 has a plurality of (e.g., six in the present embodiment) protruding portions 162 formed in pairs so that the pairs of protruding portions 162 are located at intervals in the circumferential direction and protrude radially outward from an outer peripheral surface 161 of the first driven plate 16. Inner surfaces 163 of each pair of protruding portions 162 extend in the radial direction of the first driven plate 16, are located at an interval in the circumferential direction of the first driven plate 16, and function as torque transmission surfaces that transmit and receive torque to and from the weight body 22.

As shown in FIGS. 3 to 5, each weight body 22 has two plate members 220 having the same shape, a single first coupling shaft 221, and two second coupling shafts 222. As shown in FIG. 3, each plate member 220 is made of a metal sheet and has a symmetrical, circular arc planar shape. In the present embodiment, the radius of curvature of the outer peripheral edge of each plate member 220 is the same as the radius of curvature of the outer peripheral edge of the inertial mass body 23. The two plate members 220 are coupled to each other via the single first coupling shaft 221 and the two second coupling shafts 222.

The first coupling shaft 221 is formed in the shape of a solid (or hollow) round bar. As shown in FIG. 3, the first coupling shaft 221 is fixed (coupled) to the two plate members 220 so that its axis passes through the center of gravity G of the weight body 22. The first coupling shaft 221 has an outside diameter that is smaller than the interval between the pair of protruding portions 162 (inner surfaces 163) of the first driven plate 16 and the radial length of the inner surfaces 163. The first coupling shaft 221 is slidably disposed between the pair of protruding portions 162 so as to contact one of the inner surfaces 163 of the pair of protruding portions 162. Each weight body 22 is thus coupled to the first driven plate 16 as a support member so as to be movable in the radial direction with respect to the first driven plate 16 and forms a sliding pair with the first driven plate 16. Moreover, since the first coupling shaft 221 can contact one of the inner surfaces 163 of the pair of protruding portions 162, the first coupling shaft 221 functions as a torque transmission portion that transmits and receives torque to and from the first driven plate 16. The first coupling shaft 221 may be configured to rotatably support a cylindrical outer ring via a plurality of rollers or balls (rolling elements).

The two second coupling shafts 222 of each weight body 22 are formed in the shape of a solid (or hollow) round bar. As shown in FIG. 3, the two second coupling shafts 222 of each weight body 22 are fixed to the two plate members 220 so as to be located symmetrically with respect to the centerline (see long dashed short dashed line passing through the center of rotation RC of the first driven plate 16 in FIG. 3) in the circumferential direction (the circumferential direction of the first driven plate 16 etc.) of the weight body 22 (plate members 220) which passes through the center of gravity G. That is, the axes of the two second coupling shafts 222 fixed to the two plate members 220 are located symmetrically with respect to the centerline in the circumferential direction of the weight body 22. As shown in FIGS. 3 and 5, each of the second coupling shafts 222 rotatably supports a cylindrical outer ring 224 via a plurality of rollers (rolling elements) 223, and the second coupling shaft 222, the plurality of rollers 223, and the outer ring 224 form a guided portion 225 of the weight body 22. Instead of the plurality of rollers 223, a plurality of balls may be arranged between the second coupling shaft 222 and the outer ring 224.

The inertial mass body 23 includes two annular members 230 made of a metal sheet, and the weight of the inertial mass body 23 (two annular members 230) is sufficiently heavier than that of a single weight body 22. As shown in FIGS. 3 and 5, each annular member 230 has a plurality of (e.g., six in the present embodiment) guide portions 235 formed in pairs so that the pairs of guide portions 235 are located at intervals in the circumferential direction. Each guide portion 235 is an opening extending like an arch and guides a corresponding one of the guided portions 225 of a corresponding one of the weight bodies 22. In the present embodiment, the guide portions 235 are formed in each annular member 230 so that the guide portions 235 of each pair are located symmetrically with respect to a corresponding one of straight lines extending in the radial direction from the center of the annular member 230 so as to divide the annular member 230 into three equal parts (straight lines dividing the annular member 230 into the same number of equal parts as the number of weight bodies 22).

As shown in FIG. 3, each guide portion 235 includes a concave guide surface 236 serving as a rolling surface for the outer ring 224 that forms the guided portion 225 of the weight body 22, a convex support surface 237 located closer to the inner periphery of the annular member 230 (closer to the center of the annular member 230) than the guide surface 236 is and facing the guide surface 236, and two stopper surfaces 238 located on both sides of the guide surface 236 and the support surface 237 and continuous with the guide surface 236 and the support surface 237. The guide surfaces 236 are formed so that, as the outer rings 224 roll on the guide surfaces 236 with rotation of the first driven plate 16, the center of gravity G of the weight body 22 swings with respect to (moves toward and away from) the center of rotation RC of the first driven plate 16 in the radial direction and swings about an imaginary axis 25 at a constant interaxial distance L1 to the imaginary axis 25, the imaginary axis 25 being defined so that its position relative to the inertial mass body 23 does not change. Each imaginary axis 25 is a straight line extending perpendicularly to the annular member 230 and passing through a point that is located on a corresponding one of the straight lines extending in the radial direction from the center of the annular member 230 so as to divide the annular member 230 into three equal parts (straight lines dividing the annular member 230 into the same number of equal parts as the number of weight bodies 22) and that is located at a predetermined interaxial distance L2 from the center of the annular member 230 (the center of rotation RC). The support surface 237 is a concave surface formed so as to face the guide surface 236 at an interval slightly larger than the outside diameter of the outer ring 224, and the stopper surfaces 238 are, e.g., circular arc-shaped concave surfaces.

As shown in FIG. 5, the two annular members 230 of the inertial mass body 23 are disposed on both sides in the axial direction of the first driven plate 16, one on each side, coaxially with the first driven plate 16 so that corresponding ones of the guide portions 235 face each other in the axial direction of the annular members 230.

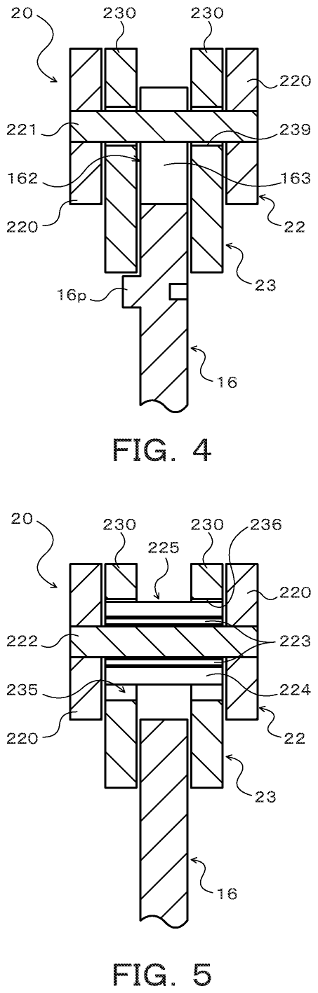

The inner peripheral surfaces of the annular members 230 are supported by a plurality of protrusions 16p (see FIGS. 3 and 4) formed on the first driven plate 16 so as to protrude in the axial direction. Each annular member 230 (inertial mass body 23) is thus supported by the first driven plate 16 so that it is rotatable about the center of rotation RC, and forms a turning pair with the first driven plate 16. The two annular members 230 may be coupled to each other via a coupling member, not shown.

The two plate members 220 of each weight body 22 are disposed so as to face each other in the axial direction with a corresponding one of the pairs of protruding portions 162 of the first driven plate 16 and the two annular members 230 interposed between the two plate members 220 and are coupled to each other by the first and second coupling shafts 221, 222. As shown in FIGS. 3 and 4, each annular member 230 of the inertial mass body 23 has circular arc-shaped openings 239, and the first coupling shafts 221 of the weight bodies 22 are inserted through the openings 239. In the present embodiment, each opening 239 is formed so that its inner surface does not contact the first coupling shaft 221. As shown in FIG. 5, each of the second coupling shafts 222 that couple the two plate members 220 extends through corresponding ones of the guide portions 235 of the two annular members 230, and each outer ring 224 is disposed in corresponding ones of the guide portions 235 of the two annular members 230.

As described above, in the vibration damping device 20, each weight body 22 and the first driven plate 16 form a sliding pair, and the first driven plate 16 and the inertial mass body 23 form a turning pair. Moreover, since the outer rings 224 of each weight body 22 can roll on the guide surfaces 236 of corresponding ones of the guide portions 235, each weight body 22 and the inertial mass body 23 form a sliding pair. The first driven plate 16, the plurality of weight bodies 22, and the inertial mass body 23 having the guide portions 235 thus form a slider crank mechanism (double slider crank chain). The equilibrium state of the vibration damping device 20 is the state in which the center of gravity G of each weight body 22 is located on a straight line passing through a corresponding one of the imaginary axes 25 and the center of rotation RC (see FIG. 3).

Next, operation of the starting device 1 including the vibration damping device 20 will be described. As can be seen from FIG. 1, in the starting device 1, when the lockup coupling has been released by the lockup clutch 8, torque (power) from the engine EG as a motor is transmitted to the input shaft IS of the transmission TM through a path formed by the front cover 3, the pump impeller 4, the turbine runner 5, and the damper hub 7. As can be seen from FIG. 1, when the lockup coupling is being performed by the lockup clutch 8, torque (power) from the engine EG is transmitted to the input shaft IS of the transmission TM through a path formed by the front cover 3, the lockup clutch 8, the drive member 11, the first springs SP1, the intermediate member 12, the second springs SP2, the driven member 15, and the damper hub 7.

When the drive member 11 coupled to the front cover 3 by the lockup clutch 8 is rotated with rotation of the engine EG while the lockup coupling is being performed by the lockup clutch 8, the first and second springs SP1, SP2 act in series via the intermediate member 12 between the drive member 11 and the driven member 15 until torque that is transmitted to the drive member 11 reaches torque T1. Torque transmitted from the engine EG to the front cover 3 is thus transmitted to the input shaft IS of the transmission TM, and fluctuation in torque from the engine EG is damped (absorbed) by the first and second springs SP1, SP2 of the damper device 10. When the torque that is transmitted to the drive member 11 becomes equal to or larger than the torque T1, fluctuation in torque from the engine EG is damped (absorbed) by the first springs SP1 of the damper device 10 until this torque reaches torque T2.

Moreover, in the starting device 1, when the damper device 10 coupled to the front cover 3 by the lockup clutch 8 by the lockup coupling rotates with the front cover 3, the first driven plate 16 (driven member 15) of the damper device 10 also rotates in the same direction as the front cover 3 about the axis of the starting device 1. With the rotation of the first driven plate 16, the first coupling shaft 221 of each weight body 22 contacts one of the inner surfaces 163 of a corresponding one of the pairs of protruding portions 162 according to the rotation direction of the first driven plate 16. As each weight body 22 is subjected to the centrifugal force, the outer rings 224 supported by the second coupling shafts 222 of each weight body 22 are pressed against the guide surfaces 236 of corresponding ones of the guide portions 235 of the inertial mass body 23 and roll on the guide surfaces 236 toward one ends of the guide portions 235 due to the moment of inertia (resistance to rotation) of the inertial mass body 23.

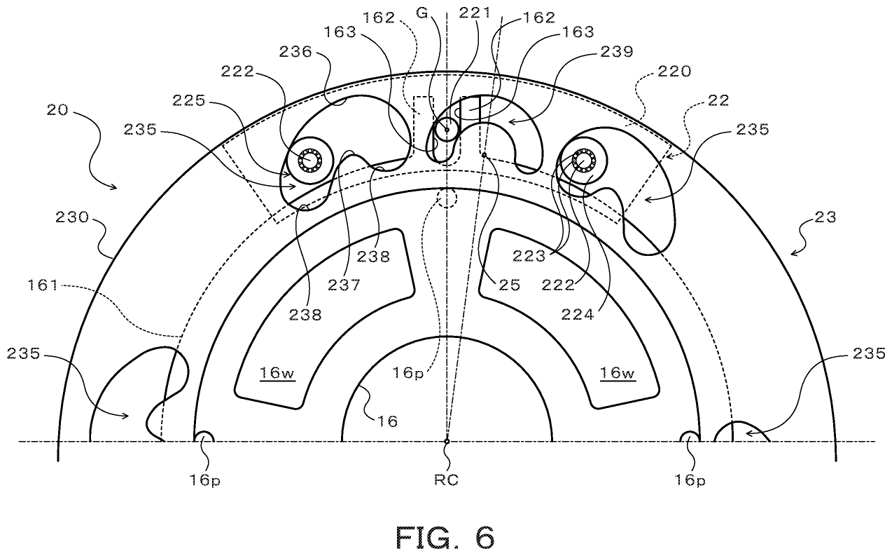

Accordingly, as shown in FIG. 6, when the first driven plate 16 rotates in one direction (e.g., counterclockwise in the figure) about the center of rotation RC, the guided portions 225, namely the outer rings 224 and the second coupling shafts 222, are guided by the guide portions 235, so that each weight body 22 (its center of gravity G) moves toward or away from the center of rotation RC in the radial direction of the first driven plate 16 without moving in the circumferential direction with respect to the first driven plate 16. At this time, rotation of each weight body 22 (its center of gravity G) on its own axis is restricted by the pair of protruding portions 162 via the first coupling shaft 221. Moreover, since the guided portions 225 are guided by the guide portions 235, the center of gravity G of each weight body 22 rotates about the imaginary axis 25 at the constant interaxial distance L1, and the inertial mass body 23 rotates about the center of rotation RC in the opposite direction to that of the first driven plate 16 accordingly.

A component of the centrifugal force acting on the center of gravity G of each weight body 22 acts as a restoring force that tries to return the inertial mass body 23 to its position in equilibrium. At the end of a swing range determined according to the amplitude of vibration (vibration level) that is transmitted from the engine EG to the first driven plate 16 (driven member 15), this component of the centrifugal force overcomes the force (moment of inertia) that tries to rotate the inertial mass body 23 in the same rotation direction as before. Accordingly, each weight body 22 moves in the opposite direction to before along the radial direction of the first driven plate 16 while being restricted from rotating on its own axis by the pair of protruding portions 162 via the first coupling shaft 221, and the inertial mass body 23 rotates about the center of rotation RC in the opposite direction to before in conjunction with each weight body 22.

As described above, when the first driven plate 16 (driven member 15) rotates in one direction, each weight body 22 serving as a restoring force generating member of the vibration damping device 20 swings (reciprocates) with respect to the center of rotation RC in the radial direction of the first driven plate 16 within a swing range about its position in equilibrium, the swing range being determined according to the amplitude of vibration (vibration level) that is transmitted from the engine EG to the driven member 15. The inertial mass body 23 swings (reciprocatively rotates) about the center of rotation RC in the opposite direction to that of the first driven plate 16 within a swing range about its position in equilibrium, the swing range being determined according to the swing range of each weight body 22. Torque (vibration) in opposite phase to fluctuating torque (vibration) transmitted from the engine EG to the drive member 11 can thus be applied from the swinging inertial mass body 23 to the first driven plate 16 via the guide portions 235, the guided portions 225, the weight bodies 22, and the first coupling shafts 221. Accordingly, by determining the specifications of the vibration damping device 20 so that the vibration damping device 20 has an order according to the order of vibration that is transmitted from the engine EG to the first driven plate 16 (excitation order: 1.5th order in the case where the engine EG is a three-cylinder engine, and second order in the case where the engine EG is a four-cylinder engine), vibration that is transmitted from the engine EG to the driven member 15 (first driven plate 16) can be satisfactorily damped by the vibration damping device 20 regardless of the rotational speed of the engine EG (first driven plate 16).

In the vibration damping device 20, motion of the weight bodies 22 coupled to the first driven plate 16 so as to be movable in the radial direction is defined (constrained) by the guided portions 225 and the guide portions 235 of the weight bodies 22 and the inertial mass body 23. The weight bodies 22 are thus not allowed to rotate on their own axes, so that the order of the vibration damping device 20 can be restrained from being reduced by an increase in equivalent mass due to rotation of the weight bodies 22 on their own axes. Moreover, the weight bodies 22 are allowed to smoothly swing with respect to the first driven plate 16, so that the centrifugal force (its component) acting on the weight bodies 22, which is used as a restoring force for swinging the inertial mass body 23, can be restrained from being damped. Restraining reduction in order due to rotation of the weight bodies 22 on their own axes allows the inertial mass body 23 to have a sufficient weight, whereby a satisfactory vibration damping effect can be provided. As a result, the vibration damping capability of the vibration damping device 20 including the weight bodies 22 that swing in the radial direction of the first driven plate 16 with rotation of the first driven plate 16 can further be improved.

In the vibration damping device 20, each weight body 22 has at least two guided portions 225 formed symmetrically with respect to the centerline in the circumferential direction of the weight body 22, and the inertial mass body 23 has two guide portions 235 for each weight body 22. This allows the weight bodies 22 to smoothly swing while being restricted from rotating on their own axes by the guide portions 235 and the guided portions 225 and reduces the friction force that is generated between the first coupling shaft 221 and the protruding portion 162. Damping of the centrifugal force acting on each weight body 22 can thus be satisfactorily restrained. A single guided portion 225 and a single guide portion 235 may be provided for each weight body 22, or three or more guided portions 225 and three or more guide portions 235 may be provided for each weight body 22.

In the vibration damping device 20, the guided portions 225 are provided in the weight bodies 22 and the guide portions 235 are formed in the inertial mass body 23. This allows the center of gravity G of each weight body 22 to be located farther away from the center of rotation RC and restrains reduction in centrifugal force acting on each weight body 22, namely reduction in restoring force acting on the inertial mass body 23. The vibration damping device 20 can thus have satisfactory vibration damping capability. In the vibration damping device 20, the guide portions 235 may be provided in the weight bodies 22 and the guided portions 225 may be formed in the inertial mass body 23.

Each guide portion 235 has the concave guide surface 236, and each guided portion 225 includes the second coupling shaft 222 serving as a shaft portion and the outer ring 224 that is rotatably supported by the second coupling shaft 222 and rolls on the guide surface 236. This allows the weight bodies 22 to more smoothly swing, so that damping of the centrifugal force acting on the weight bodies 22 can be very satisfactorily restrained.

In the vibration damping device 20, the first driven plate 16 has, as torque transmission surfaces that transmit and receive torque to and from each weight body 22, the pair of inner surfaces 163 formed so as to extend in the radial direction and to face each other at an interval in the circumferential direction of the first driven plate 16. Each weight body 22 has, as a torque transmission portion that transmits and receives torque to and from the first driven plate 16, the first coupling shaft 221 disposed between the pair of inner surfaces 163 (protruding portions 162) of the first driven plate 16 so as to contact one of the pair of inner surfaces 163. The first driven plate 16 and each weight body 22 can thus be coupled so as to transmit torque therebetween, and the friction force that is generated in the coupling portion therebetween, namely generated between the inner surface 163 and the first coupling shaft 221, can be reduced.

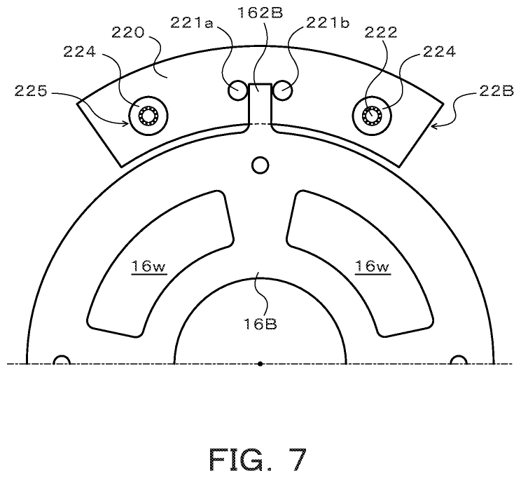

As shown in FIG. 7, a weight body 22B may have two first coupling shafts (first torque transmission portions) 221a, 221b arranged at an interval in the circumferential direction of the weight body 22B (plate members 220) (the lateral direction of the plate members 220), and a first driven plate 16B serving as a support member may have a protruding portion (second torque transmission portion) 162B extending in the radial direction and disposed between the two first coupling shafts 221a, 221b. In the example of FIG. 7, the protruding portion 162B has a width slightly smaller than the interval between the first coupling shafts 221a, 221b and is slidably disposed between the first coupling shafts 221a, 221b so as to contact one of the first coupling shafts 221a, 221b of the weight body 22B. Even with this configuration, the first driven plate 16 and the weight body 22 can be coupled so as to transmit torque therebetween, and the friction force that is generated in the joint portion therebetween, namely generated between the protruding portion 162B and the first coupling shaft 221a or 221b, can be reduced.

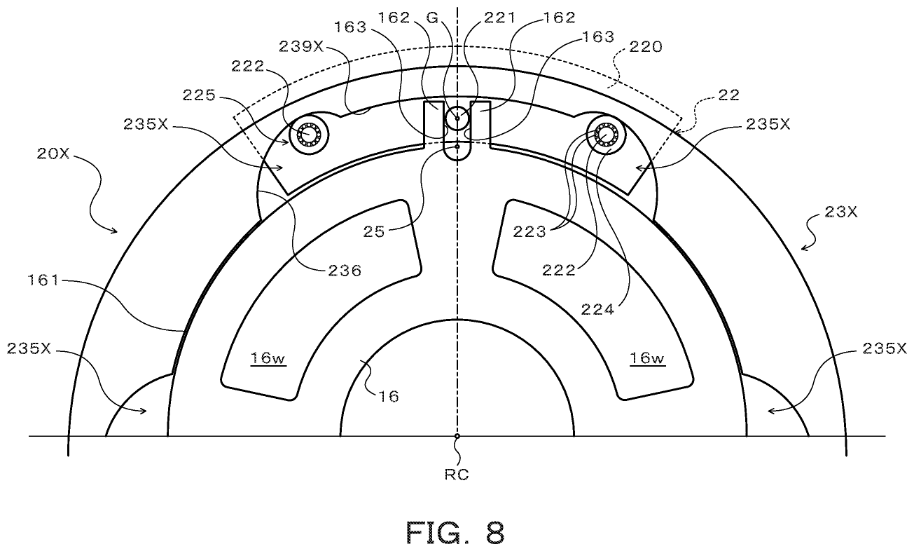

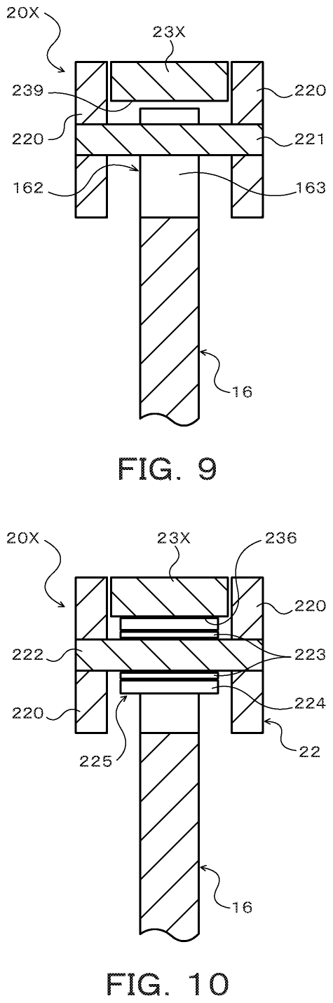

FIG. 8 is an enlarged view of another vibration damping device 20X of the present disclosure, and FIGS. 9 and 10 are enlarged sectional views of a main part of the vibration damping device 20X. Of the components of the vibration damping device 20X, the same components as those of the above vibration damping device 20 are denoted with the same reference characters as those of the vibration damping device 20, and repeated description will be omitted.

In the vibration damping device 20X shown in FIGS. 8 to 10, a single annular member is used as an inertial mass body 23X. Guide portions 235X of the inertial mass body 23X are cutouts having only a concave guide surface 236 and are equivalent to the guide portions 235 of the vibration damping device 20 having both the support surface 237 and the stopper surfaces 238 omitted therefrom. The inertial mass body 23X has a recessed portion 239X formed in its inner peripheral surface so as to be located between each pair of guide portions 235X in the circumferential direction. The inertial mass body 23X is disposed between two plate members 220 so as to surround a first driven plate 16. The inner peripheral surface (the portion other than the guide portions 235X and the recessed portions 239X) of the inertial mass body 23X is rotatably supported by an outer peripheral surface 161 of the first driven plate 16. Each protruding portion 162 of the first driven plate 16 and a first coupling shaft 221 of each weight body 22 are disposed radially inside the recessed portion 239X of the inertial mass body 23X. This vibration damping device 20X also has functions and effects similar to those of the above vibration damping device 20.

In the vibration damping device 20, 20X, the center of gravity G of each weight body 22 swings about the imaginary axis 25 at the constant interaxial distance L1 thereto. However, the present disclosure is not limited to this. That is, the vibration damping device 20, 20X may be configured so that a part of each weight body 22 other than its center of gravity G may swing about the imaginary axis 25 at a constant interaxial distance thereto. In the vibration damping device 20, 20X, the guide portions 235 that guide the guided portions 225 may be formed so that each weight body 22 follows a circular arc-shaped path when swinging with respect to the center of rotation RC in the radial direction of the first driven plate 16.

The vibration damping device 20, 20X is preferably designed so that its order (the order of vibration that is most satisfactorily damped by the vibration damping device 20, 20X; hereinafter referred to as the “effective order q_{eff}”) is higher than the sum of the excitation order q_{tag} of the engine EG and an offset value Δq determined in view of the influence of oil in the hydraulic transmission chamber 9. Experiments and analyses by the inventors show that the offset value Δq is a value of 0.05×q_{tag}<Δq≤0.20×q_{tag}, although the offset value Δq varies depending on the torque ratio and torque capacity of the starting device 1 (hydraulic transmission device), the capacity of the hydraulic transmission chamber 9, etc. The vibration damping device 20, 20X is also preferably designed so that a reference order q_{ref}, namely the value to which the effective order q_{eff} converges as the amplitude of vibration of input torque that is transmitted to the driven member 15 (first driven plate 16) decreases, is higher than the excitation order q_{tag}. In this case, the vibration damping device 20, 20X may be configured to satisfy 1.00×qtag<qref≤1.03×qtag, more preferably 1.01×qtag≤qref≤1.02×qtag. The vibration damping device 20, 20X may be configured so that the effective order q_{eff} increases as the amplitude of vibration of input torque that is transmitted from the engine EG to the driven member 15 (first driven plate 16) increases. In this case, the difference between the effective order q_{eff} at the time the amplitude of vibration of input torque is maximum and the excitation order q_{tag} of the engine EG may be either smaller than 50% of the excitation order or smaller than 20% of the excitation order. The interaxial distances L1, L2 may satisfy L1/(L1+L2)≥α+β·n, where “n” represents the number of cylinders of the engine EG and “α” and “β” are predetermined constants.

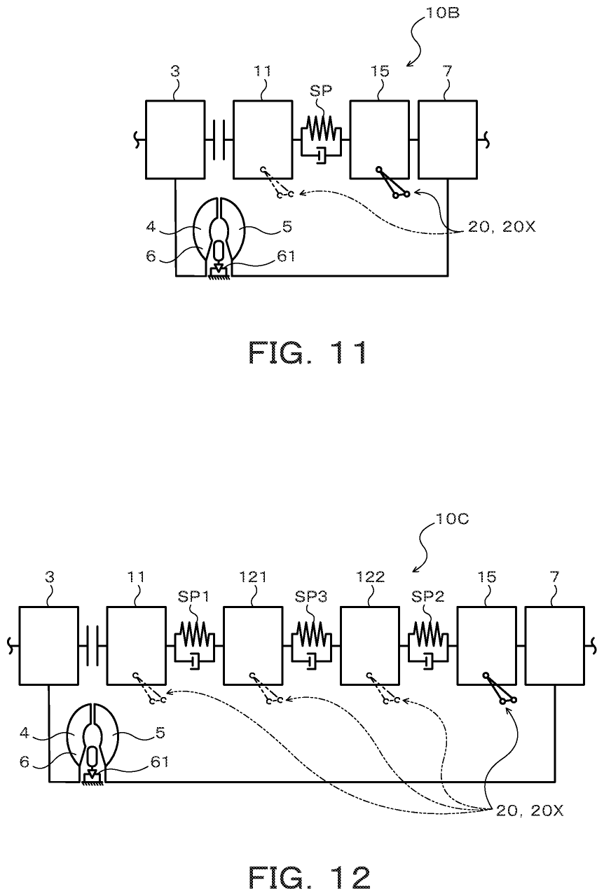

The vibration damping device 20, 20X may be coupled to the intermediate member 12 of the damper device 10 or may be coupled to the drive member (input element) 11 (see long dashed double-short dashed line in FIG. 1). The vibration damping device 20, 20X may be applied to a damper device 10B shown in FIG. 11. The damper device 10B of FIG. 11 is equivalent to the damper device 10 having the intermediate member 12 omitted therefrom, and includes a drive member (input member) 11 and a driven member 15 (output element) as rotary elements and includes, as torque transmission elements, springs SP disposed between the drive member 11 and the driven member 15. In this case, the vibration damping device 20, 20X may be coupled to the driven member 15 of the damper device 10B as shown in the figure or may be coupled to the drive member 11 as shown by long dashed double-short dashed line in the figure.

The vibration damping device 20, 20X may be applied to a damper device 10C shown in FIG. 12. The damper device 10C in FIG. 12 includes, as rotary elements, a drive member (input element) 11, a first intermediate member (first intermediate element) 121, a second intermediate member (second intermediate element) 122, and a driven member (output element) 15 and includes, as torque transmission elements, first springs SP1 disposed between the drive member 11 and the first intermediate member 121, second springs SP2 disposed between the second intermediate member 122 and the driven member 15, and third springs SP3 disposed between the first intermediate member 121 and the second intermediate member 122. In this case, the vibration damping device 20, 20X may be coupled to the driven member 15 of the damper device 10C as shown in the figure or may be coupled to the first intermediate member 121, the second intermediate member 122, or the drive member 11 as shown by long dashed double-short dashed lines in the figure. In any case, by coupling the vibration damping device 20, 20X to the rotary element of the damper device 10, 10B, 10C, vibration can be very satisfactorily damped by both the damper device 10 to 10C and the vibration damping device 20, 20X.

As described above, a vibration damping device of the present disclosure is a vibration damping device (20, 20X) including a support member (16, 16B) that rotates, together with a rotary element (15) to which torque from an engine (EG) is transmitted, about a center of rotation (RC) of the rotary element (15), a restoring force generating member (22, 22B) that is coupled to the support member (16, 16B) so as to transmit and receive the torque to and from the support member (16, 16B) and that is swingable with rotation of the support member (16, 16B), and an inertial mass body (23, 23X) that is coupled to the support member (16, 16B) via the restoring force generating member (22, 22B) and that, with rotation of the support member (16, 16B), swings about the center of rotation (RC) in conjunction with the restoring force generating member (22, 22B). The vibration damping device (20, 20X) further includes: a guided portion (225) formed in one of the restoring force generating member (22, 22B) and the inertial mass body (23, 23X); and a guide portion (235, 235X) formed in the other of the restoring force generating member (22, 22B) and the inertial mass body (23, 23X) and configured to guide the guided portion (225). As the guided portion (225) is guided by the guide portion (235, 235X), the restoring force generating member (22, 22B) swings with respect to the center of rotation (RC) in a radial direction of the support member (16, 16B) and the inertial mass body (23, 23X) swings about the center of rotation (RC) when the support member (16, 16B) rotates.

In the vibration damping device of the present disclosure, when the support member rotates with the rotary element, the guided portion formed in one of the restoring force generating member and the inertial mass body is guided by the guide portion formed in the other of the restoring force generating member and the inertial mass body. The restoring force generating member thus swings in the radial direction of the support member, and the inertial mass body swings about the center of rotation in conjunction with the restoring force generating member. When the inertial mass body swings about the center of rotation, the inertial mass body applies torque in opposite phase to fluctuating torque that is transmitted from the engine to the rotary member to the support member via the restoring force generating member. Vibration of the rotary element can thus be satisfactorily damped. In the vibration damping device of the present disclosure, motion of the restoring force generating member coupled to the support member is defined (constrained) by the guided portion and the guide portion which are formed in the restoring force generating member and the inertial mass body. The restoring force generating member is thus not allowed to rotate on its own axis, so that reduction in order of the vibration damping device due to rotation of the restoring force generating member on its own axis can be restrained. Moreover, the restoring force generating member is allowed to smoothly swing with respect to the support member, so that damping of a centrifugal force (its component) acting on the restoring force generating member, which is used as a restoring force for swinging the inertial mass body, can be restrained. As a result, vibration damping capability of the vibration damping device including the restoring force generating member that swings in the radial direction of the support member with rotation of the support member can further be improved.

At least two of the guided portions (225) and at least two of the guide portions (235, 235X) may be provided for the single restoring force generating member (22, 22B). This allows the restoring force generating member to smoothly swing while being restricted from rotating on its own axis by the guide portions and the guided portions, whereby damping of the centrifugal force acting on the restoring force generating member can be satisfactorily restrained.

The restoring force generating member (22, 22B) may have the two guided portions (225) or the two guide portions (235, 235X) formed symmetrically with respect to a centerline in a circumferential direction of the restoring force generating member (22, 22B), and the inertial mass body (23, 23X) may have the two guide portions (235, 235X) or the two guided portions (225) for the single restoring force generating member (22, 22B).

The restoring force generating member (22, 22B) may swing in the radial direction without moving with respect to the support member (16, 16B) in a circumferential direction of the support member (16, 16B) and the inertial mass body (23, 23X) may swing in the circumferential direction, as the two guided portions (225) are guided by the two guide portions (235, 235X).

The guide portion (235, 235X) may guide the guided portion (225) so that, when the support member (16, 16B) rotates, the restoring force generating member (22, 22B) swings with respect to the center of rotation (RC) in the radial direction of the support member (16, 16B) and swings about an imaginary axis (25), the imaginary axis (25) being defined so that its position relative to the inertial mass body (23, 23X) does not change.

The guided portion (225) may be provided in the restoring force generating member (22, 22B), and the guide portion (235, 235X) may be formed in the inertial mass body (23, 23X). This allows the center of gravity of the restoring force generating member to be located farther away from the center of rotation and restrains reduction in centrifugal force acting on the restoring force generating member, namely reduction in restoring force acting on the inertial mass body. The vibration damping device can thus have satisfactory vibration damping capability.

The guide portion (235, 235X) may include a concave guide surface (236), and the guided portion (225) may include a shaft portion (222) and an outer ring (224) that is rotatably supported by the shaft portion (222) and that rolls on the guide surface (236). This allows the restoring force generating member to more smoothly swing, so that damping of the centrifugal force acting on the restoring force generating member can be very satisfactorily restrained.

The support member (16) may have a pair of torque transmission surfaces (163) formed so as to extend in the radial direction and to face each other at an interval in the circumferential direction of the support member (16), and the restoring force generating member (22) may have a torque transmission portion (221) disposed between the pair of torque transmission surfaces (163) of the support member (16) so as to contact at least one of the pair of torque transmission surfaces (163). The support member and the restoring force generating member can thus be coupled so as to transmit torque therebetween, and a friction force that is generated therebetween can be reduced.

The restoring force generating member (22B) may have a pair of first torque transmission portions (221a, 221b) disposed at an interval in the circumferential direction of the restoring force generating member (22B), and the support member (16B) may have a second torque transmission portion (162B) disposed between the pair of first torque transmission portions (221a, 221b) of the restoring force generating member (22B) so as to extend in the radial direction and to contact at least one of the pair of first torque transmission portions (221a, 221b). Even with this configuration, the support member and the restoring force generating member can be coupled so as to transmit torque therebetween, and the friction force that is generated therebetween can be reduced.

The support member may be a single plate member (16, 16B), the inertial mass body (23) may include two annular members (230) disposed on both sides in the axial direction of the plate member (16, 16B), and the restoring force generating member (22, 22B) may include two members (220) disposed on both sides in the axial direction of the two annular members (230).

The support member (16, 16B) may rotate coaxially and together with one of a plurality of rotary elements (11, 12, 121, 122, 15) of a damper device (10, 10B, 10C), the damper device (10, 10B, 10C) having the rotary elements (11, 12, 121, 122, 15) including at least an input element (11) and an output element (15) and an elastic body (SP, SP1, SP2, SP3) that transmits the torque between the input element (11) and the output element (15). Since the vibration damping device is thus coupled to the rotary element of the damper device, vibration can be very satisfactorily damped by both the damper device and the vibration damping device.

The output element (15) of the damper device (10, 10B, 10C) may be operatively (directly or indirectly) coupled to an input shaft (IS) of a transmission (TM).

The various aspects of the present disclosure are not limited in any way to the above embodiments, and it is to be understood that various modifications can be made without departing from the spirit and scope of the present disclosure. The modes for carrying out the aspects described above merely show specific forms of the aspects described in the section “SUMMARY OF THE DISCLOSURE” and are not intended to limit the elements of the invention described in the section “SUMMARY OF THE DISCLOSURE.”

### INDUSTRIAL APPLICABILITY

The various aspects of the present disclosure are applicable to the manufacturing field of vibration damping devices that damp vibration of rotary elements, etc.

1-12. (canceled)

13. A vibration damping device including a support member that rotates, together with a rotary element to which torque from an engine is transmitted, about a center of rotation of the rotary element, a restoring force generating member that is coupled to the support member so as to transmit and receive the torque to and from the support member and that is swingable with rotation of the support member, and an inertial mass body that is coupled to the support member via the restoring force generating member and that, with rotation of the support member, swings about the center of rotation in conjunction with the restoring force generating member, the vibration damping device comprising:
a guided portion formed in one of the restoring force generating member and the inertial mass body; and
a guide portion formed in the other of the restoring force generating member and the inertial mass body and configured to guide the guided portion, wherein
as the guided portion is guided by the guide portion, the restoring force generating member swings with respect to the center of rotation in a radial direction of the support member and the inertial mass body swings about the center of rotation when the support member rotates.

14. The vibration damping device according to claim 13, wherein
at least two of the guided portions and at least two of the guide portions are provided for the single restoring force generating member.

15. The vibration damping device according to claim 14, wherein
the restoring force generating member has the two guided portions or the two guide portions formed symmetrically with respect to a centerline in a circumferential direction of the restoring force generating member, and
the inertial mass body has the two guide portions or the two guided portions for the single restoring force generating member.

16. The vibration damping device according to claim 14, wherein
as the two guided portions are guided by the two guide portions, the restoring force generating member swings in the radial direction without moving with respect to the support member in a circumferential direction of the support member and the inertial mass body swings in the circumferential direction.

17. The vibration damping device according to claim 15, wherein
as the two guided portions are guided by the two guide portions, the restoring force generating member swings in the radial direction without moving with respect to the support member in a circumferential direction of the support member and the inertial mass body swings in the circumferential direction.

18. The vibration damping device according to claim 13, wherein
the guide portion guides the guided portion so that, when the support member rotates, the restoring force generating member swings with respect to the center of rotation in the radial direction and swings about an imaginary axis, the imaginary axis being defined so that a position of the imaginary axis relative to the inertial mass body does not change.

19. The vibration damping device according to claim 13, wherein
the guided portion is provided in the restoring force generating member, and the guide portion is formed in the inertial mass body.

20. The vibration damping device according to claim 13, wherein
the guide portion includes a concave guide surface, and
the guided portion includes a shaft portion and an outer ring that is rotatably supported by the shaft portion and that rolls on the guide surface.

21. The vibration damping device according to claim 13, wherein
the support member has a pair of torque transmission surfaces formed so as to extend in the radial direction and to face each other at an interval in the circumferential direction of the support member, and
the restoring force generating member has a torque transmission portion disposed between the pair of torque transmission surfaces of the support member so as to contact at least one of the pair of torque transmission surfaces.

22. The vibration damping device according to claim 13, wherein
the restoring force generating member has a pair of first torque transmission portions disposed at an interval in the circumferential direction of the restoring force generating member, and
the support member has a second torque transmission portion disposed between the pair of first torque transmission portions of the restoring force generating member so as to extend in the radial direction and to contact at least one of the pair of first torque transmission portions.

23. The vibration damping device according to claim 13, wherein
the support member is a single plate member,
the inertial mass body includes two annular members disposed on both sides in the axial direction of the plate member, and
the restoring force generating member includes two members disposed on both sides in the axial direction of the two annular members.

24. The vibration damping device according to claim 13, wherein
the support member rotates coaxially and together with one of a plurality of rotary elements of a damper device, the damper device having the rotary elements including at least an input element and an output element and an elastic body that transmits the torque between the input element and the output element.

25. The vibration damping device according to claim 24, wherein
the output element of the damper device is operatively coupled to an input shaft of a transmission.
